(19) United States
(12) Patent Application Publication
(10) Pub. No.: US 2022/0155949 A1
(43) Pub. Date: May 19, 2022

(54) Intent Driven Dynamic Gesture Recognition System

(71) Applicant: Ultraleap Limited, Bristol (GB)

(72) Inventors: Lazlo Ring, Mountain View, CA (US); Jim Provan, Bristol (GB)

(21) Appl. No.: 17/454,823

(22) Filed: Nov. 15, 2021

Related U.S. Application Data
(60) Provisional application No. 63/114,513, filed on Nov. 16, 2020.

(51) Int. Cl. G06F 3/0488; G06T 11/00; G06F 3/0482; G06F 3/0481; G06F 3/01; G06F 3/0485

(52) U.S. Cl. CPC G06F 3/04883; G06T 11/00; G06F 3/0482; G06T 2200/24; G06F 3/04812; G06F 3/016; G06F 3/0485; G06F 3/04817

(57) ABSTRACT

Described herein is an embodiment that maps the various windows and controls that make up a program into different context sensitive areas for gestural intents. This embodiment allows for a limited set of gestures to be dynamically mapped to emulate different inputs at runtime. Through this approach, the embodiment can easily translate existing mouse/keyboard/touchscreen UI inputs to be used through gestural interfaces. A proposed method is set forth herein for the machine path and for decision maker.

### PRIOR APPLICATIONS

This application claims the benefit of the following application, which is incorporated by references in its entirety:

Ser. No. 63/114,513, filed Nov. 16, 2020.

### FIELD OF THE DISCLOSURE

The present disclosure relates generally to improved techniques in recognizing and interpreting dynamic gestures in haptic systems.

### BACKGROUND

A mid-air haptic feedback system creates tactile sensations in the air. One way to create mid-air haptic feedback is using ultrasound. A phased array of ultrasonic transducers is used to exert an acoustic radiation force on a target. This continuous distribution of sound energy, which will be referred to herein as an “acoustic field”, is useful for a range of applications, including haptic feedback.

It is known to control an acoustic field by defining one or more control points in a space within which the acoustic field may exist. Each control point is assigned an amplitude value equating to a desired amplitude of the acoustic field at the control point. Transducers are then controlled to create an acoustic field exhibiting the desired amplitude at each of the control points.

Tactile sensations on human skin can be created by using a phased array of ultrasound transducers to exert an acoustic radiation force on a target in mid-air. Ultrasound waves are transmitted by the transducers, with the phase emitted by each transducer adjusted such that the waves arrive concurrently at the target point in order to maximize the acoustic radiation force exerted.

By defining one or more control points in space, the acoustic field can be controlled. Each point can be assigned a value equating to a desired amplitude at the control point. A physical set of transducers can then be controlled to create an acoustic field exhibiting the desired amplitude at the control points. Gesture recognition is a key part of this acoustic system. Such recognition may be based on hand gestures and/or eye gestures.

As technology evolves, designers are often faced with the problem of trying to adapt existing systems to use newer technology. In the field of Human Computer Interaction this is no exception, as the same input modalities have been used for the last 30+ years. But a new wave of user input technology—hand gesture recognition systems—has finally become cheap and robust enough to warrant its use in interacting with the digital world. That said, the effort to convert the millions of existing user interfaces (UIs) to a gesture-based one is not a trivial task. A simple conversion of hand motion to a single set of mouse input often will not suffice due to the complexity of these systems.

To address this, designed herein is an approach to enable UI systems to dynamically adapt how gestures are translated to UI inputs based on the UI elements that the user is currently interacting with. By doing this, it is possible to translate a range of gestures to cover a variety of different tasks of the UI of a program without requiring the end user to do anything more than map the intents of various pieces of their UI. The user does not need to implement these gestures directly into their application, meaning the gestures may also be incorporated into any already existing applications.

There have been multiple attempts to find ways to easily integrate gesture recognition systems into existing user interfaces. As earlier as 2012, Leap Motion (now Ultraleap) developed systems that convert hand gestures to emulated touch inputs. However, the gestures were unaware of the application that the user was interacting with, so the gestures were converted directly into basic “dumb inputs,” such as single mouse clicks. If the application was more complex and required more complex actions such as zooming, the user would need to change to a different mode that might not be suitable for more simplistic interactions such as button clicking.

Another way of introducing gesture interactions to an application was to employ a capable developer to implement gesture interactions directly into the target application. However, this requires developer time and cost to the application designer. This solution would also only support the single application it was implemented in. The designer would then need to design user instructions into their application for the gestures they have implemented.

Disclosed herein is an embodiment that allows an entire application's UI to be dynamically mapped to gesture interactions without having to manually change interaction modes. The solution is sensitive to the context the interaction is taking place in. It can also be used without needed to implement any gestures into an application, and can be used with any already existing application without any developer time spent. The user instruction can also be deployed across multiple application and interaction contexts by providing on-screen overlay instructions. In this way, both existing and new UIs can include new hand gesture recognition systems. This results in a seamless translation of a small set of gesture into a nearly infinite space of emulated inputs.

### SUMMARY

This embodiment maps the various windows and controls that make up a program into different context sensitive areas for gestural intents. This embodiment allows for a limited set of gestures to be dynamically mapped to emulate different inputs at runtime. Through this approach, the embodiment can easily translate existing mouse/keyboard/touchscreen UI inputs to be used through gestural interfaces. A proposed method is set forth herein for the machine path and for decision maker.

Traditional systems that attempt to add a new mode of interaction to an existing UI usually depend on a simple one-to-one mapping of actions in the new input system to actions in the old input system. This embodiment uses operating system level information about the programs running on the system to map input actions to application designer intents, allowing us to go beyond this simple one-to-one translation.

This novelty is at least based on reading in operating system level information about how the application is designed and rendered to the screen, and then mapping this information to the application designers' intents. By doing this, the embodiment can then provide application developers a simple way of upgrading existing interfaces to create highly dynamic gestural interfaces that would have previously only been available by training a user on how to large set of gestural commands or by writing a bespoke solution. In addition, the embodiment goes beyond this simple mapping by allowing examples such as augmenting the screen with additional information or fundamentally change how gestures are recognized/used within the system in a seamless manner to the user.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIG. 1 shows a flowchart showing the steps of the disclosed method for recognizing and processing dynamic gestures.

FIG. 2 shows an example web page rendered in a modern web browser with a variety of interactive elements.

FIG. 3 shows an example web page highlighting interactable elements on the page are interactable.

FIG. 4 shows an example of HTML code to be processed and presented to the user.

FIG. 5 shows an example of a mapping code stored into a file for use at runtime.

FIG. 6 shows an example of an intent translation mapping file.

FIG. 7 shows an example of an operating system native application prior to window detection.

FIG. 8 shows an example of an operating system native application after interaction window detection.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

I. Introduction

When a new input device is developed, there is often a large lead-up time before its mass adoption due to the development effort required to incorporate it into new or existing applications. To speed up this process, many device designers attempt to build intermediate tools or APIs that simply translate inputs from the new device to be recognizable to the inputs the system was previously designed for. One of the most relevant examples of this is touch screen interfaces, where a user's touches are translated to mouse positions and button clicks. While this works nicely in simple one-to-one translations, more complex input devices often require bespoke solutions to take advantage of their full range of capabilities. A simple example of this problem is pinch-to-zoom: in a map-application context, zooming in is often accomplished with the mouse wheel. If the mouse wheel were mapped to a pinch gesture, this would enable expected behavior in the map application. This one-to-one correspondence falls apart, however, when moving to a browser, where mouse wheel input performs a scroll action. Without changing the mapping in the context of the browser, pinching would result in scrolling instead of zooming, the expected behavior. This means that application designers will often have to release new or updated versions of their existing software to take advantage of these new methods of input. As gestural interfaces become more commercially viable due to their reliability and cost, it has become exceedingly clear that they are no exception, and that simple one-to-one correspondence will likely not do

What makes gestural interfaces fundamentally different to almost all previous input devices is that the users' interaction space is nearly limitless as it consists of the whole world around them. Because of this, users may not initially know what actions they are supposed to perform and how those actions will be translated to the interactions they have done in the past. As a result, users are often confused or frustrated when first interacting with these systems since they are required to learn a large amount of information prior to their first interaction. This is a problem that is only exacerbated by more complex applications. This results in application designers having to rebuild their systems from the ground up to incorporate these gestural interfaces or requiring users to partake in a lengthy tutorial prior to use.

To ease the effort of allowing future and existing applications to take advantage of gestural interfaces, the embodiment presented here illustrates a method of mapping windows and other interface items found within these applications to the application designers' intents. These intents are represented as simple labels that are applied to their application through a mapping process that allows them to designate radically different behaviors from the gestural interface based on the content being shown by the application. Through this novel mapping approach, designers can easily map a single gesture to a vast range of emulated inputs, dynamically augment what is being displayed on the screen based on a user's action, or even change parameters within the gesture recognition system itself without having to touch a line of code in their existing applications.

This embodiments may call an operating systems accessibility or automation API (such as MSAA or IUIAutomation in Windows) to get a list of all window handles of the programs actively running on the machine. From these handles, information such as the title of the window, its parents/children, any controls it may have, and most importantly the element's metadata such as its name, type, and bounding box, is obtained. “Window handles” may be generalized herein to mean any user interface. “Window handle identifier” may be generalized herein to mean any user interface element.

With this information stored, it is possible to query the same API to see what elements are present under a virtual cursor to determine which elements the user is intending to interact with. Since this all happens at the lowest level of the operating system, any application that provides accessibility information for its UI using the operating system's built-in accessibility APIs, becomes identifiable. This includes applications such as web pages, natively written applications, and the operating system itself.

Once the information about the elements within an application has been acquired, the application designer maps them to their intended actions from within the solution. This will be referred to as “intent translation mapping.” Since these APIs provide information about the target applications ranging from large, embedded frames to single icons, the designers may specify the level of control they want over this mapping with fine precision. This mapping can then be piped into a traditional retrofitting system, where it is checked to determine whether the system's representation of a virtual cursor is within the bounding box of any of the mapped elements, and if so, what the intended action is for operating on, or within, that element.

Once the application developer has mapped the intents of the elements found in their application, the system can store these for use at runtime. With this information, the system can be fed the current intent based on its virtual cursor position, allowing it to dynamic adjust its properties in real time. These types of adjustments may be broken down into five distinct categories:
Changing the programs gesture to input mappings.
Changing which set of gestures are currently being tracked.
Changing properties related to how the virtual cursor is implemented.
Changing the visuals representation of the cursor.
Displaying additional information on the screen.

II. Changing the Programs Gesture to Input Mappings

Different user interfaces often require different modes of interaction. A simple example of this is the difference between how a user interacts with a button versus how a user interacts with a slider. When a user interacts with a button, the operating system is looking for input to be translated to a mouse click (left click down, left click up). When a user interacts with a slider, however, the interaction is expected to be a left mouse down event, mouse movement, and then a left mouse up event once the user has dragged the slider to the target position. In traditional approaches, it is necessary to explicitly go to a settings menu or interact with an on-screen trigger to change a single action mapping to accommodate these two different interactions at runtime. The present embodiment, however, detects when the user is over an element designated as a slider versus a button and changes the emulated input mapping automatically during interaction via a mapping table.

III. Changing which Set of Gestures are Currently being Tracked

In gestural interfaces, different interactions come with different trade-offs, whether it be precision, comfort or ease of use. An example of this is the difference between a “pinch” gesture and a “push” gesture. In the “pinch” gesture, the gestural interface can easily detect when the user is doing the intended action (looking for two touching fingers), allowing for an easy distinction of on/off actions. However, this precision requires the user to be more careful with their overall movements, resulting in them needing finer motor skills throughout the interaction. A “push” gesture on the other hand requires users to perform a relatively distinct event for the interaction to be detected, resulting in less false positives. In custom solutions, designers must manually code their whole system to use a specific action in each part, such as using the “push” gesture to interact with buttons versus using the “pinch” gesture to do fine motion tasks like writing a signature. In this embodiment, the same level of customization in a retrofitted solution is allowable since the embodiment can assign different gestures to different intents, such as using a “push” gesture by default and then swap to a “pinch” gesture when over a signature field.

IV. Changing Properties Related to how the Virtual Cursor is Implemented

Similar to how different gestures can be used for different activities, the space and sensitivity in which a gesture is detected is often a feature that requires specific customization in bespoke solutions. One such use case can be found when interacting with buttons of various sizes. In Human Computer Interaction, Fitts' Law has shown us that the size of a button directly correlates to the speed and accuracy in which it can be hit. However, by automatically detecting the size of the button a user is hovering over, the embodiment can automatically adjust the amount of gestural space required to traverse through it. This means that the embodiment can dynamically make a small button require the same amount of motion to pass through it as a large one.

V. Changing the Visuals Representation of the Cursor

When using a traditional mouse, the operating system will update the size and shape of a cursor depending on the task at hand. This means that when a user is moving around a map for example, the icon will change from a pointer to a hand to give the user contextual clues as to what they are interacting with and how it should be manipulated. In this algorithm, the same affordances can be applied to retrofitted interfaces by having the overlayed cursor change shape based on the content underneath it.

VI. Displaying Additional Information on the Screen

Educating the user is often a challenge in novel interfaces, since the use has to be taught how to interact with the new input system and how these inputs relate to the interface they are using. Traditionally this is solved by adding instructional panels next to the device itself or adding new wording/artwork to the application to guide the users through it. Since this embodiment allows for the system to be aware of the gesture that needs to be performed at any given time, contextual messages may be overlayed onto the screen to help guide the user on how to complete their interactions without requiring extra work from the application developer. These contextual messages can be as simple as have text appear on the screen to state what actions they need to perform to showing animated guides illustrating what the user has to do next. Additionally, since the system can try and infer the intended action being performed, context appropriate error messages can be displayed based on the gesture mapped to a given element. For example, the embodiment may inform users that they have to move their hand back to perform a certain gesture.

VII. Adapting to Biometric User Data

In addition to adjusting the gesture recognition systems to the elements found beneath the virtual cursor, biometric data about the user can also be feed into the system to adjust the way it behaves. Similar to the intent adaptations mentioned previously, this data would be supplied as into to the intent translation system, further adjusting the behavior of the gesture recognition system. Examples of this include, but are not limited to, adjust the interaction space of the recognition system based on a user's height, or further remapping the gesture space to accommodate for a user's limited mobility.

VIII. Building Codeless Interfaces Through Intents

Another key outcome of the intent-driven approach is that it allows for application designers to iterate on their interfaces with little to no code. By utilizing the concept that the intent translation system only requires a panel and a unique name/identifier to work, designers may create a simple mock-up design of their application by placing blank panels throughout their interface. Once these panels are mapped, they can be used by the intent translation system to overlay the necessary graphics/mock interactivity necessarily to prototype their designs. Custom intents can be used to further aid in this task, by allowing designers to quickly pass input from one control to another without having to touch the underlying application.

IX. Intent Translation Mapping Description

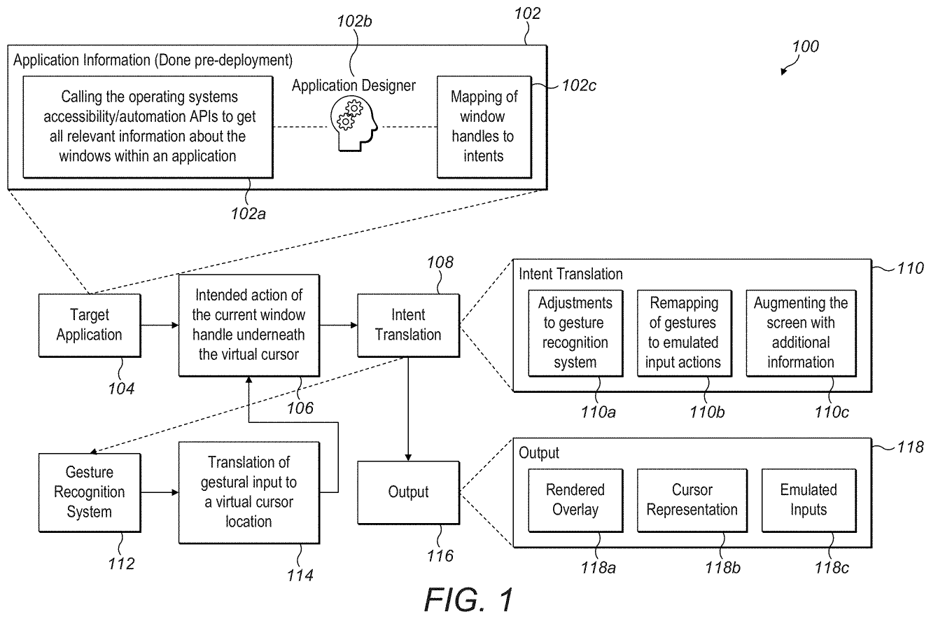

Turning to FIG. 1, shown is a schematic 100 of an intent translation process that may take place in two stages: an information gathering stage done prior to deployment, and a dynamic adaption stage that occurs during runtime.

The purpose of the pre-deployment stage is to gather the information required for the intent translation process including the target application that is run alongside this embodiment.

Specifically, the target application 104 engages with the pre-deployment application as shown in box 102. These interfaces are performed by calling the operating systems accessibility/automation APIs to get all relevant information about the windows within an application 102a interfacing with the application director 102b and mapping of window handles to intents 102c.

The target application system 104 then interfaces with the intended action of the current window handle underneath the virtual cursor 106 and then moves on to the intent translation phase 108. An expanded view of the intent translation phase 108 is shown expanded in box 110. This includes adjustments to gesture recognition system 110a, remapping of gestures to emulated input actions 110b, and augmenting the screen with additional information 110c, and, optionally, controlling the mid-air haptic feedback given to the user.

The intent translation phase 108 then proceeds to the output stage 116. The output stage is shown in an expanded box 118. This output stage includes a rendered overlay 118a, a cursor representation 118b, and emulated inputs 118c.

The intent translation phase 108 also interfaces to a gesture recognition system 112, which proceeds to a translation of gestural input to a virtual cursor location 114. This proceeds to the intended action of the current window handle underneath the virtual cursor 106.

More specifically, once started, the algorithm calls into the operating systems accessibility/automation application programming interfaces (APIs) to get a list of all active top-level window handles, then traverses the hierarchy to gather any child window handles, application controls or defined areas (such as buttons or panes), and their corresponding identifiers, bounding boxes, metadata, etc. Each window, control, or defined area is a single element of the application. This information is then stored internally and is displayed to the user as a list of potentially mappable windows and controls, along with a list of supported interaction intents. The target application's designer must then designate which elements map to which intents for use at runtime.

This process is repeated across the entire target application until all elements that the designer wants to map has been gathered. Additionally, the designer may manually specify a region of the screen that does not correspond to a specific element and map an intent to it.

In the post-deployment stage, after the initial mapping has been completed, the gesture recognition system 112 can then be run. The intent translation system 108 is agnostic to the inner workings of the gesture recognition system and only requires the virtual cursor's current position. This information is provided to the intent translation system 108, 110 at runtime in a real-time update loop.

In this process, this embodiment uses a virtual cursor within the target application 106 to query the operating systems accessibility/automation APIs for the element beneath the cursor each update cycle. Once an element is acquired, the system will check against the application designer's map to see if the given element relates to any intent, and if not, it will check if the parent of that element has an intent until either an intent is found or no parent element exists.

If no intent is found for the given element, the intent translation systems default settings are passed to the output stage of the program. If an intent is found, the corresponding changes for that intent are applied to the gesture recognition system 112, input mapping 114, and output system 116 accordingly.

Once intent translation has occurred, the final output of the intent translation system 118 is produced, rendering any overlay graphics that are needed 118a, such as the cursor 118b or additional instructional information, and emulating the input required for the target application to run 118c.

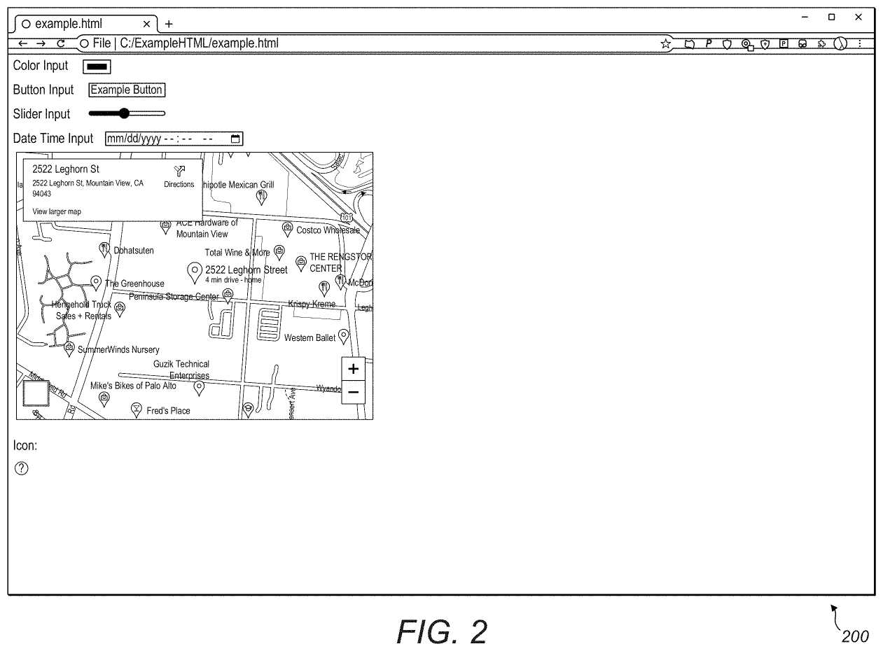

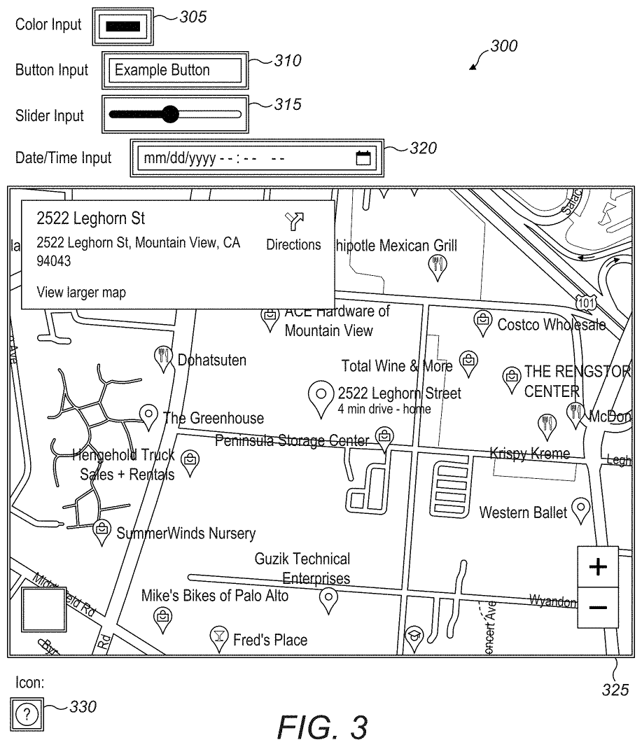

To better illustrate this embodiment, an example web page with various types of input methods will be shown. Turning to FIG. 2, shown is an example web page 200 rendered in a modern web browser with a variety of interactive elements. Turning to FIG. 3, shown is a schematic 300 highlighting which elements on the page in FIG. 2 are interactable after pulling data from the operating systems accessibility API. Shown are color input 305, button input 310, slider input 315, date/time input 320, and icon 330 with their bounding boxes.

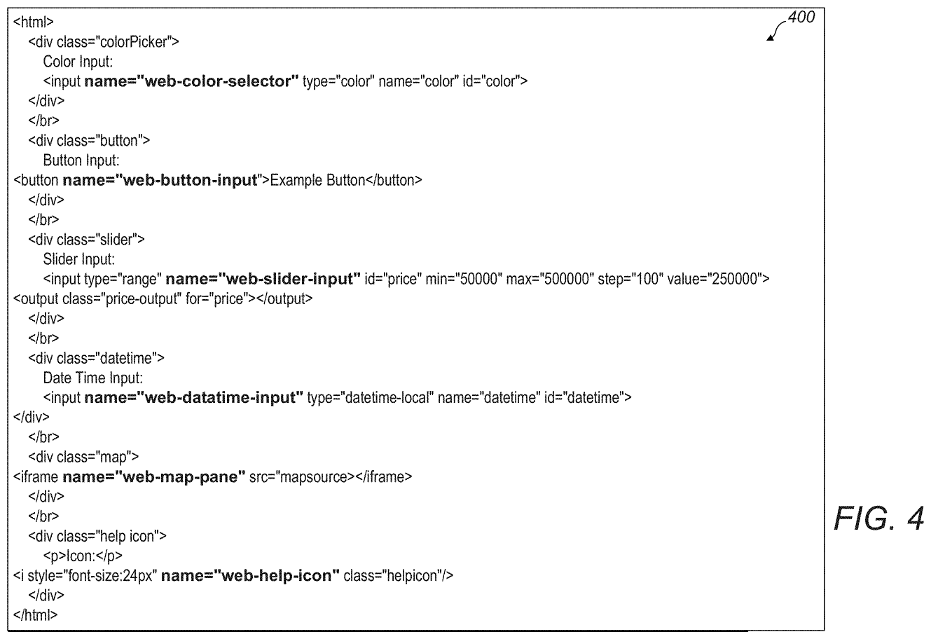

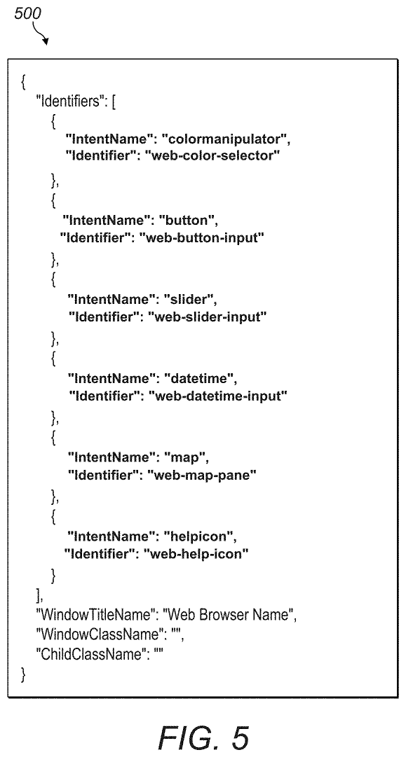

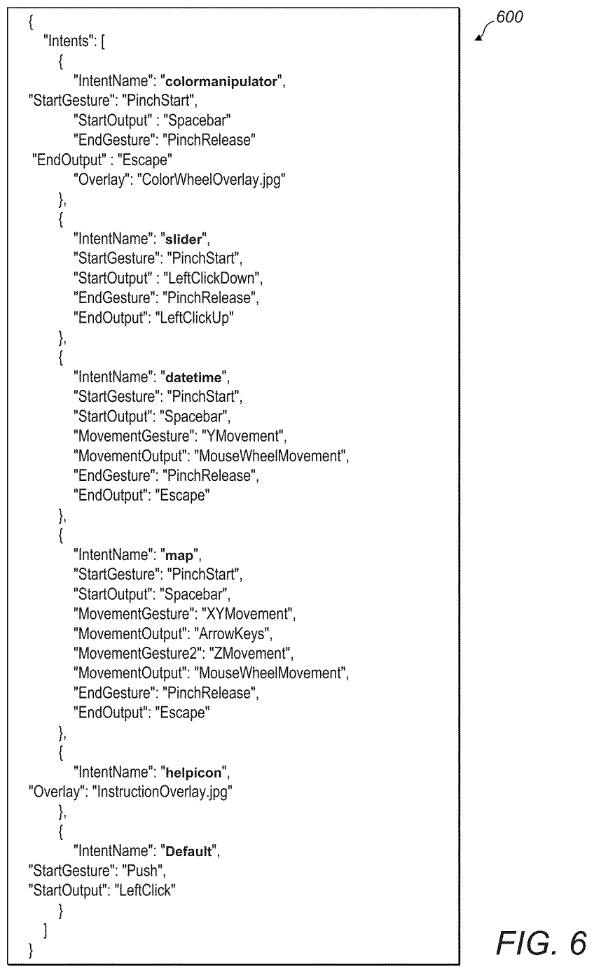

Turning to FIG. 4, shown is code 400 showing the names associated with each element of the web page as presented to the user (bolded elements in the code), where the user is asked to associate each one with a given intent. Turning to FIG. 5, shown is this mapping stored into a file 500 for use at runtime (carrying forward the bolded elements in the code from FIG. 4). This maps the target application's name and intent to element mapping needed for the system. Within the system, each intent can then be mapped to a set of parameters that when adjusted, aid the user in completing their task for the given gesture recognition system. Turning to FIG. 6, shown is an example intent translation mapping file 600 (carrying forward the bolded elements in the code from FIGS. 4 and 5).

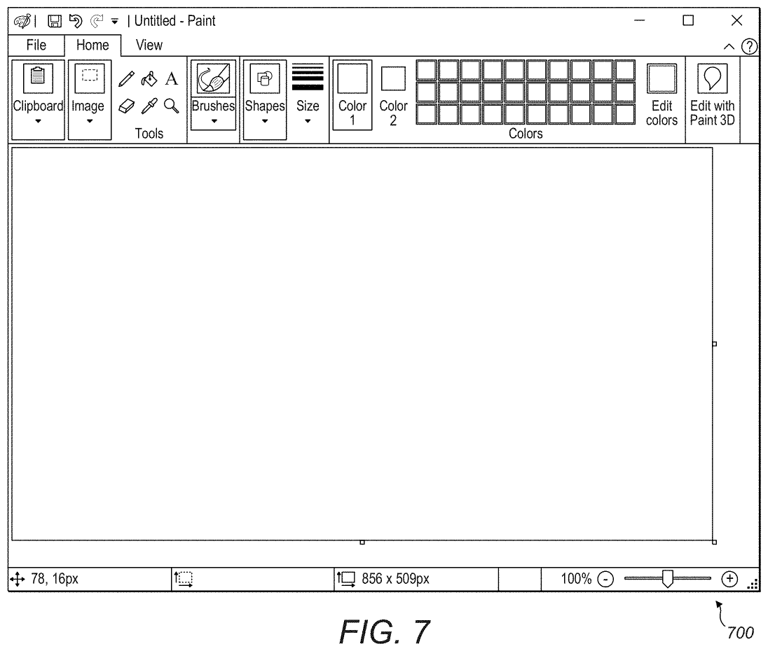

Turning to FIG. 7, shown is an example 700 of an operating system native application prior to window detection.

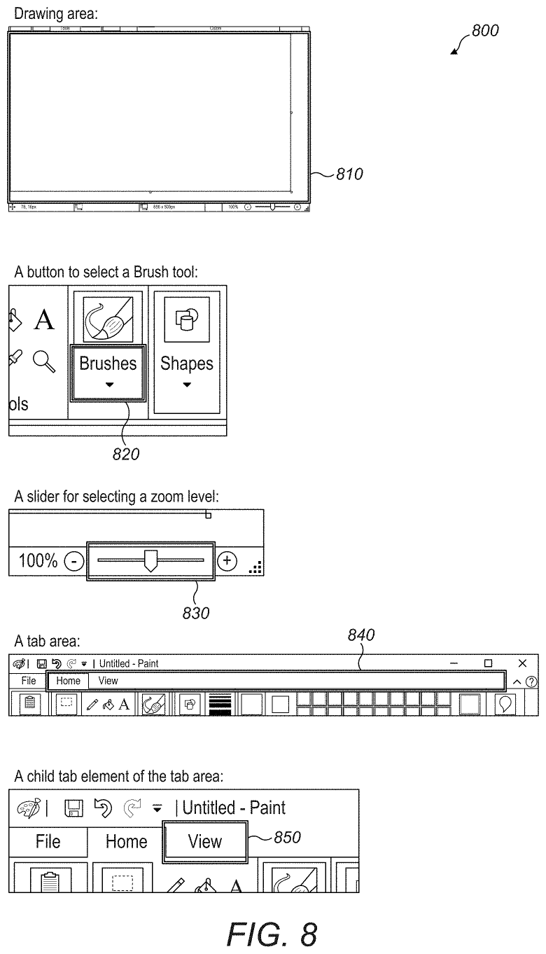

Turning to FIG. 8, shown is an example 800 of an operating system native application after interaction window detection. Such windows include drawing areas 810, brushes 820, sliders 830, tabs 840, and child elements of a tab 850.

Another example of intent translation mapping may look like the following for a hand-recognition system:
Button Input/Default (when the virtual cursor is not over an intent)
   The virtual cursor is mapped one-to-one with the user's hand in front of the screen, with the user being able to trigger a mouse click (down and up) by pushing their hand towards the screen.
Color Selection
   A pinch gesture is looked for to open the color pane (via a spacebar emulation), and then all horizontal and vertical hand movements are translated to cursor positions within the color wheel until a pinch release occurs.
Slider Input
   A pinch gesture is looked for and converted to a click and hold, with a click up occurring on pinch release.
Date/Time Input
   A pinch gesture is looked for to select the month/day/year field, with vertical movements being translated to mouse wheel up and down motions during the pinch.
Scrollable Map
   A pinch gesture is looked for and converted to a click and hold, with a click up occurring on pinch release. Moving the hand left, right, up, and down while performing a click and hold moves the mouse cursor to pan the map. Depth motions towards or away from the screen are converted to mouse wheel up/down to zoom in and out.
Help Icon
   When the virtual cursor moves over the icon, instructional graphic appears on the screen to explain how to perform the required gestures to interact with each of the above input fields via hand gestures.

Alternatively, if the same example is used with an eye-tracking system, the intent translation mapping may look like the following:
Button Input/Default (when the virtual cursor is not over an intent)
   The virtual cursor is mapped to the user's gaze, with a mouse click (down and up) occurring activating after user has continuously at a given spot for 2 seconds.
Color Selection
   Once the panel has been selected by the default method, a double blink is looked for within the color panel to have a mouse click occur at the last gaze spot to confirm a color selection.
Slider Input
   A double blink gesture is looked for and converted to a click and hold, with a second double blink being translated to a click up event to release the slider knob.
Date Time Input
   Once the panel has been selected by the default method, a calendar overlay appears, highlighting a date corresponding to their current gaze position. After gazing continuously at a date for X number of seconds, the date is translated to a series of keystrokes that would result in the dates selection (I.E., left click, 1, 1, tab, 1, 5, tab, 2, 0, 2, 0).
Scrollable Map
   Once the panel has been selected by the default method, an overlay is drawn onto the rest of the screen to signify to the user that the map is in use. By gazing at the corners of the map, arrow key presses are sent to the application to pan around the map. Gazing at the overlay for 2 seconds causes the map to lose focus and the overlay to disappear.
Help Icon
   When the virtual cursor moves over the icon, instructional graphic appears on the screen to explain how to perform the required gestures to interact with each of the above input fields via eye movements.

X. Summary

In summary, this embodiment consists of 2 elements: intent tags attached to interface elements and intent translation mapping. The intent tags are mapped to elements within an interface system and describe the how the application designer intended for them to be interacted with. These tags are then referenced by the intent translation mapping which describes the best practices performing the given intent based on the gesture recognition platform being used. By separating these two concepts (intent and intent translation), it is possible to dynamically adapt or redesign user interfaces from either the interface side or the gesture recognition side independently. An interface mapped to intents may be used with different gesture recognition devices without needing to redesign it. Likewise, a gesture recognition system with adequate intent translation mapping could be used portably across multiple different intent tagged interfaces without having to alter the underlying application.

The various features of the foregoing embodiments may be selected and combined to produce numerous variations of improved haptic-based systems. Specifically, the output of Intent Translation 108 may also be used to give users feedback via a mid-air haptics system. This may allow various parts of the program to have distinct haptic feedback, giving the user further contextualized clues on the intents inferred by the underlying system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
an intent mapping method, comprising:
obtaining, by an application programming interface, at least one user interface and its associated user interface element defining a single element of an application; and
for each of the at least one user interface, associating at least one interaction intent to the at least one user interface;
a gesture recognition method, comprising:
for each update cycle, using a virtual cursor within an application to query the application programming interface to determine whether there is an element beneath the cursor;
upon acquiring the element, determining if the element is associated with the at least one interaction intent;
if the element is associated with the at least one interaction intent: (a) applying corresponding changes from the at least one interaction intent to an intent translation system, the intent translation system comprising gesture recognition system, an input mapping system, and an output system; and (b) producing, by the intent translation system, instructional information to emulate input required for the application.

2. The method as in claim 1, further comprising:
if the element is not associated with the at least one interaction intent, providing default settings to the intent translation system.

3. The method as in claim 1, wherein the instruction information includes overlay graphics.

4. The method as in claim 1, wherein associating at least one interaction intent to the at least one user interface includes displaying a list of potentially mappable windows and controls, and a list of supported interaction intents.

5. The method as in claim 1, wherein querying the application programming interface to determine whether there is an element beneath the cursor further comprises determining if a parent element of the element has an intent until either an intent is found or no parent element exists.

6. The method as in claim 1, wherein the intent translation system further comprises controlling mid-air haptic feedback given to a user.

7. The method as in claim 1, wherein the intent mapping method further comprises a hand recognition system relating to button input.

8. The method as in claim 1, wherein the intent mapping method further comprises a hand recognition system relating to color selection.

9. The method as in claim 1, wherein the intent mapping method further comprises a hand recognition system relating to slider input.

10. The method as in claim 1, wherein the intent mapping method further comprises a hand recognition system relating to date and time input.

11. The method as in claim 1, wherein the intent mapping method further comprises a hand recognition system relating to a scrollable map.

12. The method as in claim 1, wherein the intent mapping method further comprises a hand recognition system relating to a help icon.

13. The method as in claim 1, wherein applying corresponding changes from the at least one interaction intent to an intent translation system includes changing program gesture to input mappings.

14. The method as in claim 1, wherein applying corresponding changes from the at least one interaction intent to an intent translation system includes changing which set of gestures are currently being tracked.

15. The method as in claim 1, wherein applying corresponding changes from the at least one interaction intent to an intent translation system includes changing properties related to how the cursor is implemented.

16. The method as in claim 1, wherein applying corresponding changes from the at least one interaction intent to an intent translation system includes changing visuals representation of the cursor.

17. The method as in claim 1, wherein applying corresponding changes from the at least one interaction intent to an intent translation system includes displaying additional information on a screen.

18. The method as in claim 1, wherein applying corresponding changes from the at least one interaction intent to an intent translation system includes using biometric data of a user.

19. The method as in claim 1, wherein applying corresponding changes from the at least one interaction intent to an intent translation system does not require altering the application.
